(19) United States
(12) Patent Application Publication
(10) Pub. No.: US 2010/0253834 A1
(43) Pub. Date: Oct. 7, 2010

(54) CAMERA MODULE AND MOBILE TERMINAL UNIT

(75) Inventor: Koji OGANE, Nagano (JP)

Correspondence Address: KRATZ, QUINTOS & HANSON, LLP, 1420 K Street, N.W., 4th Floor, WASHINGTON, DC, 20005, US

(73) Assignee: SHINKO ELECTRIC INDUSTRIES CO., LTD., Nagano-shi (JP)

(21) Appl. No.: 12/754,915

(22) Filed: Apr. 6, 2010

(30) Foreign Application Priority Data
Apr. 7, 2009 (JP) 2009-092607

(51) Int. Cl. H04N 5/225

(52) U.S. Cl. 348/374; 348/E05.027; 348/E05.028

(57) ABSTRACT

A camera module includes a wiring substrate on which an imaging device is mounted to an upper surface side thereof, and a lens holding frame which is arranged on the wiring substrate and in which a lens portion is housed, wherein a plurality of concave portions are provided side by side to a lower part of an inner wall of the lens holding frame in a height direction, and an end part of the wiring substrate is fitted in the concave portion of the lens holding frame and is fixed thereto. A holding member having elasticity in an upper and lower direction is provided to stand to an inside part of the lens holding frame, and a top end part of the holding member touches an upper surface of the wiring substrate, and thereby the wiring substrate is held.

### CROSS-REFERENCE TO RELATED APPLICATIONS

This application is based on and claims priority of Japanese Patent Application No. 2009-092607 filed on Apr. 7, 2009, the entire contents of which are incorporated herein by reference.

### BACKGROUND OF THE INVENTION

1. Field of the Invention

The present invention relates to a camera module built in a cellular phone, or the like and a mobile terminal unit including the same.

2. Description of the Related Art

In the prior art, the camera module for constructing a camera portion of the mobile terminal unit has been developed. Such camera module is basically constructed by fitting a lens holding frame (lens holder) in which a lens, etc. are housed onto a wiring substrate on which an imaging device is mounted.

In Patent Literature 1 (Patent Application Publication (KOKAI) 2008-172724), it is set forth that a convex portion is formed on an inside wall surface of a side wall portion of a pedestal which holds a lens unit, and then a glass cover is held to the pedestal by press-fitting the glass cover to which an imaging device is joined while running onto the convex portion.

In the prior art, as the method of assembling the camera module, there is the method of coating an adhesive on a peripheral portion of a wiring substrate on which an imaging device is mounted, then mounting a lens holding frame on the wiring substrate, and then connecting the wiring substrate and the lens holding frame by curing the adhesive in the curing furnace.

In recent years, in the camera module which is installed into the cellular phone, a further miniaturization is required and a size of the wiring substrate must be set smaller than an outer shape of the lens holding frame. Therefore, the area where the adhesive is formed can not be ensured sufficiently. As a result, there is such a possibility that reliability of the connection between the wiring substrate and the lens holding frame becomes a problem.

Also, a relatively long process time is needed when the adhesive is cured by applying the heat treatment. Therefore, there is a problem that the production efficiency is low.

### SUMMARY OF THE INVENTION

It is an object of the present invention to provide a camera module and a mobile terminal unit, in which a wiring substrate and a lens holding frame can be connected together with good reliability even when the camera module is miniaturized.

The present invention is concerned with a camera module, which includes a wiring substrate on which an imaging device is mounted to an upper surface side thereof; and a lens holding frame arranged on the wiring substrate and in which a lens portion is housed; wherein a plurality of concave portions are provided side by side to a lower side of an inner wall of the lens holding frame in a height direction, and an end part of the wiring substrate is fitted into the concave portion of the lens holding frame and is fixed thereto.

In the camera module of the present invention, a plurality of concave portions are provided to a lower side of an inner wall of the lens holding frame side by side in the height direction, and the end part of the wiring substrate is fitted into the concave portion of the lens holding frame. When the wiring substrate is to be fitted to the lens holding frame, the end part of the wiring substrate is fitted into the concave portion positioned at an optimum height out of a plurality of concave portions by moving the wiring substrate in the upper and lower direction.

By doing this, when the wiring substrate is to be fitted to the lens holding frame, a focus adjustment can be done by finely adjusting a distance between the lens portion and the imaging device.

In one preferred mode of the present invention, the camera module further includes a holding member which is provided to stand toward the lower side to an inside part of the lens holding frame, and which has elasticity in the upper and lower direction, and the wiring substrate is held in such a way that a top end part of the holding member touches an upper surface of the wiring substrate.

Accordingly, the wiring substrate can be fitted into the concave portion positioned at a desired height in a state that the wiring substrate is held from the upper side by the holding member. Therefore, the wiring substrate can be fixed stably to the concave portion. As the method of giving the holding member the elasticity, for example, the top end part of the holding member may be formed as a bending portion, or a curving portion may be provided to a half way position in the height direction of the holding member.

Also, in one preferred mode of the present invention, a conductor layer may be provided from the side surface of the holding member to the lower surface of the top end thereof, and the holding member may also be served as a connection terminal of the lens holding frame. Then, the conductor layer formed on the lower surface of the top end of the holding member serves as the connection portion, and is connected electrically to a connection pad of the wiring substrate.

Accordingly, even though the connection terminal is not particularly provided to the lens holding frame, the wiring substrate is electrically connected to the actuator which drives the lens portion and is arranged in the lens holding frame, via the conductor layer formed on the holding member.

As explained above, in the present invention, even when the camera module is miniaturized, the wiring substrate and the lens holding frame can be connected together with good reliability.

### BRIEF DESCRIPTION OF THE DRAWINGS

FIG. 1 is a sectional view showing a wiring substrate and a lens holding frame for constructing a camera module according to a first embodiment of the present invention;

FIG. 2 is a plan view of the lens holding frame in FIG. 1 when viewed from the lower side;

FIG. 3 is a sectional view showing the camera module in the first embodiment of the present invention;

FIG. 4 is a sectional view showing a state of a connection portion of the camera module in the first embodiment of the present invention;

FIG. 5 is a sectional view showing a camera module according to a variation of the first embodiment of the present invention;

FIG. 6 is a sectional view showing a camera module according to a second embodiment of the present invention;

FIG. 7 is a plan view of the lens holding frame before the camera module in FIG. 6 is assembled, when viewed from the lower side;

FIG. 8 is a sectional view showing a camera module according to a variation of the second embodiment of the present invention; and

FIG. 9 is external views showing a cellular phone including the camera module in the embodiment of the present invention.

### DETAILED DESCRIPTION OF THE PREFERRED EMBODIMENTS

Embodiments of the present invention will be explained with reference to the accompanying drawings hereinafter.

### First Embodiment

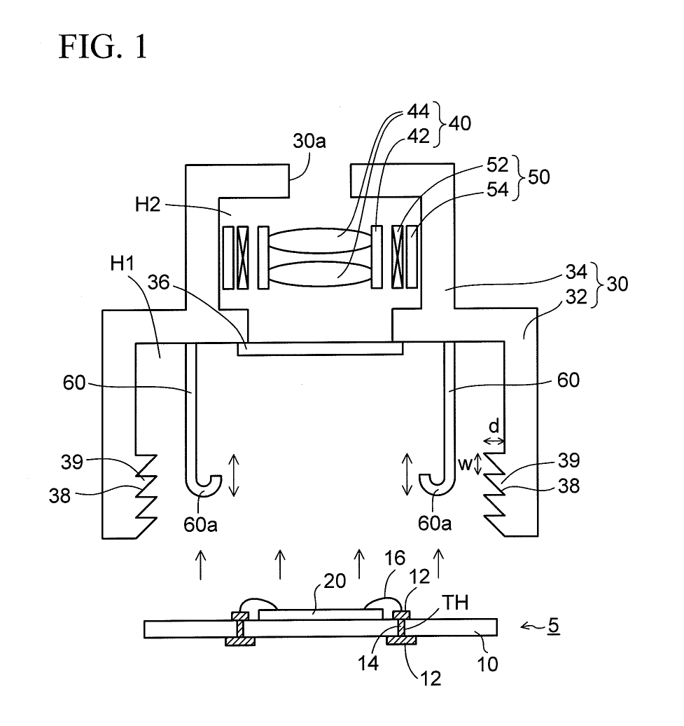

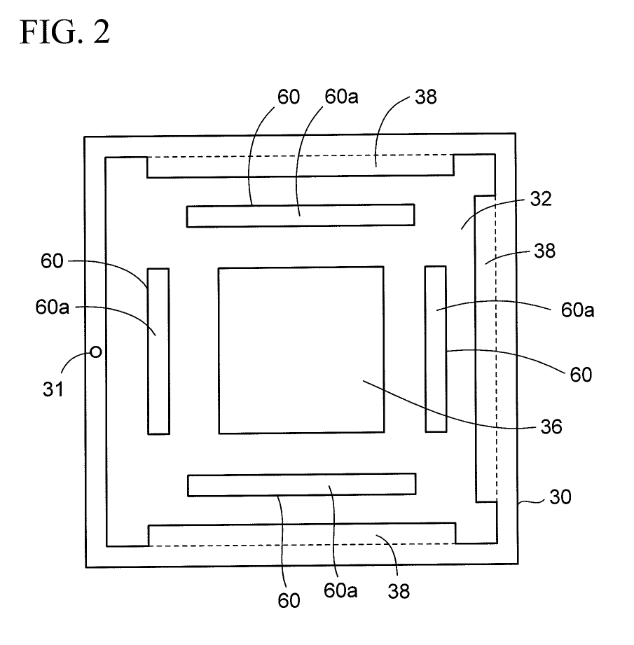

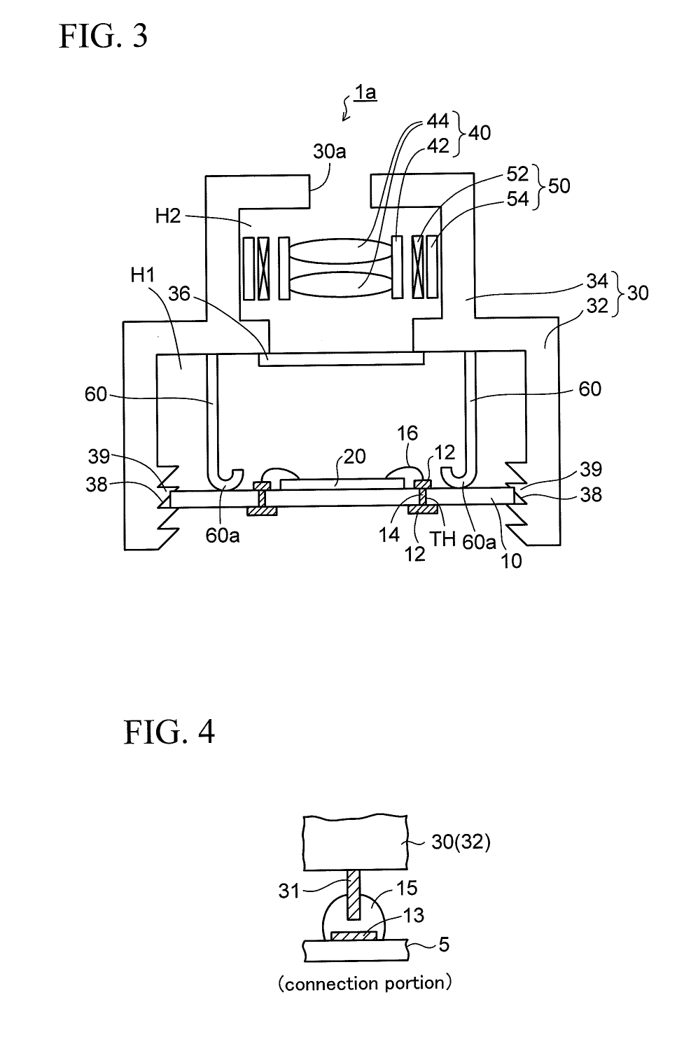

FIG. 1 is a sectional view showing a wiring substrate and a lens holding frame for constructing camera module according to a first embodiment of the present invention, FIG. 2 is a plan view of the lens holding frame in FIG. 1 when viewed from the lower side, and FIG. 3 is a sectional view showing the camera module similarly.

As shown in FIG. 1, in order to construct a camera module in the first embodiment, a wiring substrate 5 and a lens holding frame 30 in which a lens portion 40, or the like are housed are prepared.

In the wiring substrate 5, a wiring layer 12 is formed on both surface sides of an insulating substrate 10 made of a resin, or the like respectively. Through holes TH which penetrate in the thickness direction are provided in the insulating substrate 10. The wiring layers 12 on both surface sides are connected to each other via penetrating electrodes 14 which are formed in the through holes TH.

An imaging device 20 such as CCD, a CMOS sensor, or the like is mounted on the upper surface side of the wiring substrate 5. Electrodes of the imaging device 20 are connected to the wiring layers 12 of the wiring substrate 5 via a wire 16 respectively. The wiring substrate 5 may have a multilayer wiring on both surface sides, and the wiring substrates having various structures can be employed.

The lens holding frame 30 is constructed by a first frame portion 32, and a second frame portion 34 arranged thereon, and has a frame structure whose inside part is a hollow. In the example in FIG. 1, the first frame portion 32 of the lens holding frame 30 is a square-like frame in which the inside part is hollowed, and the second frame portion 34 is a cylindrical-like frame whose diameter is smaller than the first frame portion 32.

A first housing portion H1 is constructed by the first frame portion 32 of the lens holding frame 30 in the inside part thereof, and a second housing portion H2 is constructed by the second frame portion 34 of the lens holding frame 30 in the inside part thereof.

The lens portion 40 is housed in the second housing portion H2 of the lens holding frame 30. The lens portion 40 is constructed by a holding body 42 having a cylindrical-like shape, and a lens group 44 which are held in the holding body 42 and are arranged side by side in the vertical direction.

Also, a voice coil motor (VCM) 50 acting as an actuator to drive the lens portion 40 is arranged to the outer peripheral side of the lens portion 40. The voice coil motor 50 is constructed by a coil 52 which is wound on the outer periphery of the holding body 42 of the lens portion 40, and a magnet 54 arranged on the outer peripheral side of the coil 52.

By applying a required current to the coil 52 of the voice coil motor 50, the lens portion 40 receives a propulsion force in the optical axis direction (in FIG. 1, upper and lower direction) based on the so-called linear motor principle, and can be driven.

That is, the lens portion 40 is driven forward and backward by the function of the voice coil motor 50, and a focus of the image is adjusted. A spring (not shown) is attached to the lens portion 40, and the lens portion 40 can be is returned to a normal position by this spring.

Here, the voice coil motor 50 is illustrated as the actuator used to drive the lens portion 40. In this case, the lens portion 40 may be driven by utilizing a piezoelectric motor (not shown) as the actuator. In the piezoelectric motor, an inverse piezoelectric effect is utilized, expansion/contraction of the crystals occur by applying a voltage to the piezoelectric element, and thereby the lens portion 40 can be driven.

Also, an opening portion 30a is provided in the center part of the upper surface of the second frame portion 34 of the lens holding frame 30. A glass window having optically isotropic may be sealed to the opening portion 30a of the lens holding frame 30.

Further, a glass plate 36 is provided between the first housing portion H1 and the second housing portion H2 of the lens holding frame 30 so that the glass plate 36 partitions them. The glass plate 36 functions as an infrared (IR) cut filter.

Also, a plurality of concave portions 38 having groove shape are provided side by side in the height direction to a lower side of an inner wall of the first frame portion 32 of the lens holding frame 30. A plurality of convex portions 39 which protrude inside and have triangle-like shape are arranged in the height direction. Accordingly, the V-shaped concave portion 38 is formed between the convex portions 39 respectively, and a plurality of concave portions 38 are arranged like a stripe in the height direction.

An inner diameter of the first frame portion 32 corresponds to an outer shape of the wiring substrate 5, and the end part of the wiring substrate 5 can be fitted in major parts of the concave portions 38 which are provided to the first frame portion 32. A width w and a depth d (FIG. 1) of the concave portion 38 are set to consider a thickness of the wiring substrate 5 such that the end part of the wiring substrate 5 can be stably fitted into the concave portion 38. For example, a width w of the concave portion 38 is set to 50 to 500 μm, and a depth d of the concave portion 38 is set to 0.5 to 1 mm.

A plurality of concave portions 38 are arranged side by side in the height direction. Therefore, when the wiring substrate 5 is fitted to be hooked to the concave portion 38, a height position of the imaging device 20 can be adjusted by positioning the wiring substrate 5 to the concave portion 38 of an optimum height.

In the example in FIG. 1, three concave portions 38 are provided in the height direction of the first frame portion 32. But the number of concave portions 38 can be set arbitrarily.

Also, a holding member 60 provided to stand toward the lower side is fixed to a ceiling portion of the first frame portion 32 of the lens holding frame 30. The holding member 60 is provided so as to fix the wiring substrate 5 stably in the concave portion 38 to hold the wiring substrate 5 from the upper side, when the end part of the wiring substrate 5 is fitted into the concave portion 38 of the first frame portion 32.

A top end part of the holding member 60 is formed of a bending portion 60a that is folded to the inside like a “J”-shape. Accordingly, the holding member 60 has the elasticity in the upper and lower direction. Therefore, when the end part of the wiring substrate 5 is fitted into the concave portion 38 of the first frame portion 32, the height position of the wiring substrate 5 can be easily adjusted in a state that the wiring substrate 5 is held from the upper side by the holding member 60.

That is, in the state in FIG. 1, the lower surfaces of the bending portions 60a of the holding members 60 are arranged at the position of the lowermost concave portion 38. Also, when the wiring substrate 5 is fitted to the lens holding frame 30, the holding member 60 can be moved to the position of the highest concave portion 38 by the elasticity thereof.

In FIG. 2, a state of the lens holding frame 30 in FIG. 1 when viewed from the lower side is shown.

As explained with adding FIG. 2 to FIG. 1, in the present embodiment, four plate-like holding members 60 are provided to be separated to the periphery side of the ceiling portion of the first frame portion 32 in the lens holding frame 30. Otherwise, rod-like (column) holding members 60 may be provided in plural to the first frame portion 32.

Also, as shown in FIG. 2, in the present embodiment, the concave portions 38 are provided to the lower parts of the inner walls of three sides of the first frame portion 32 having square shape respectively. No concave portion 38 is provided to the remaining one side of the first frame portion 32, and a connection terminal 31 is provided to the lower surface of the top end thereof. The connection terminal 31 is connected electrically to the coil 52 of the voice coil motor 50.

In the case that the connection terminal 31 is provided to stand toward the lower side from the ceiling portion of the first frame portion 32, the concave portions 38 may be provided to all inner walls of the first frame portion 32. Otherwise, the concave portions 38 may be provided only to a pair of opposing inner walls of the square first frame portion 32.

Then, as shown in FIG. 1 and FIG. 3, the wiring substrate 5 is pushed into the lower part of the first frame portion 32 of the lens holding frame 30 in a state that the wiring substrate 5 is held in the horizontal direction. At this time, first, the end part of the wiring substrate 5 is inserted to run onto the lowermost convex portion 39, and then is fitted into the lowermost concave portion 38.

Then, by pushing up the wiring substrate 5 to the upper side, the wiring substrate 5 runs onto the convex portion 39 and then is fitted into the concave portion 38 in arbitrary position. It is possible that the wiring substrate 5 fitted into the concave portion 38 is moved to lower side, and is returned to the concave portion 38 of the lower side.

In the present embodiment, the convex portion 39 is formed like a triangular shape and the upper surface side of the convex portion 39 is arranged to direct toward the horizontal direction, thereby the wiring substrate 5 can be moved to the upper side smoothly. At this time, the bending portions 60a of the holding member 60 touch the upper surface of the wiring substrate 5. As described above, since the holding member 60 has the elasticity in the upper and lower direction, the wiring substrate 5 can be moved toward the upper side in a state that the bending portions 60a of the holding member 60 touch the upper surface of the wiring substrate 5.

Accordingly, when the wiring substrate 5 is fitted into the concave portion 38 of the lens holding frame 30 and attached thereto, a focus adjustment can be done by finely adjusting a distance between the imaging device 20 and the lens portion 40. In the example in FIG. 3, the wiring substrate 5 is fitted into the concave portion 38 of the second position from the bottom in the lens holding frame 30.

In addition, the wiring substrate 5 is fitted into the concave portion 38 in the state that the wiring substrate 5 is held to be pushed to the lower side by the holding member 60. Therefore, the wiring substrate 5 is fixed without vertical wobble to the concave portion 38 with good reliability.

Here, preferably the concave portions 38 and the holding members 60 provided to the lens holding frame 30 are formed integrally with a main body by pouring a resin into the mold. Otherwise, the resin component to which the convex portions 39 and the concave portions 38, or the like may be fixed to the lower part of the inner wall of the lens holding frame 30. Also, the holding members 60 may be prepared as the separate component, and it is also possible to fix the holding members 60 to the lens holding frame 30.

Also, in the present embodiment, the V-shaped concave portion 38 is provided between the triangular convex portions 39 to the lower part of the inner wall of the lens holding frame 30. But the convex portions 39 and the concave portions 38 may have the shape in which the wiring substrate 5 can be move to the upper and lower direction and also the wiring substrate 5 can be fitted into the concave portion 38, thus the concave portion 38 with various shapes can be employed.

In FIG. 4, a state of a connection portion to connect electrically the lens holding frame 30 side and the wiring substrate 5 is shown. As shown in FIG. 4, when the wiring substrate 5 is attached to the lens holding frame 30, the connection terminal 31 (FIG. 2) which is provided to the top end of the lower surface of the lens holding frame 30, described above, is connected electrically to a connection pad 13 which is provided to one end of the wiring substrate 5, by a connection conductor 15 such as silver paste, solder, or the like.

Then, the required current is applied to the coil 52 of the voice coil motor 50 from the driver IC (not shown) that is mounted on the wiring substrate 5, and thus the voice coil motor 50 is driven.

As described above, when the connection terminal is provided to stand to lower side from the ceiling portion of the first frame portion 32, the connection terminal is similarly connected electrically to the connection pad of the wiring substrate 5 via the silver paste, or the like.

In this manner, the wiring substrate 5 is attached to the lower part of the lens holding frame 30, and the imaging device 20 which is mounted on the wiring substrate 5 is housed in the first housing portion H1 of the lens holding frame 30. As a result, a camera module la in the first embodiment is constructed.

As shown in FIG. 3, in the camera module la in the first embodiment, an external light transmits the lens group 44 and then transmits the glass plate 36 located under them. At this time, the glass plate 36 acts as an IR cut filter that cuts off the light of an infrared (IR) range except the visible light from the external light.

Then, the light which has transmitted the glass plate 36 is incident to the imaging device 20, and the imaging device 20 converts optical signals into electric signals. And based on this, image data are produced.

In the case that the focus of the image is not suitable, an electric current is applied from the driver IC (not shown) mounted on the wiring substrate 5 to the coil 52 of the voice coil motor 50 via the connection pad 13 of the wiring substrate 5, the connection terminal 31 of the lens holding frame 30, etc. so as to change the position of the lens portion 40. Accordingly, the position of the lens portion 40 is changed by the function of the voice coil motor 50, and thus a focus is adjusted.

In the camera module 1a in the first embodiment, the wiring substrate 5 is fitted into the concave portion 38 provided to the lens holding frame 30, and is fixed thereto without the application of the adhesive.

Therefore, unlike the prior art, the steps of applying the adhesive and then curing the adhesive by the heat treatment are not needed. As a result, a material cost of the adhesive can be reduced, and the manufacturing steps can be greatly shortened. Also, even when an area where the adhesive is provided cannot ensured sufficiently on account of the miniaturization of the camera module, the wiring substrate 5 can be connected easily to the lens holding frame 30 by providing the concave portions 38 to the lower part of the inner wall of the lens holding frame 30.

In addition, by positioning a plurality of concave portions 38 side by side in the height direction, a focus of the image can be adjusted by finely adjusting the height position of the imaging device 20.

Also, the wiring substrate 5 is fixed to the concave portion 38 of the lens holding frame 30 in a state that the wiring substrate 5 is pushed to the lower side by the holding member 60. Therefore, sufficient reliability of connection can be ensured.

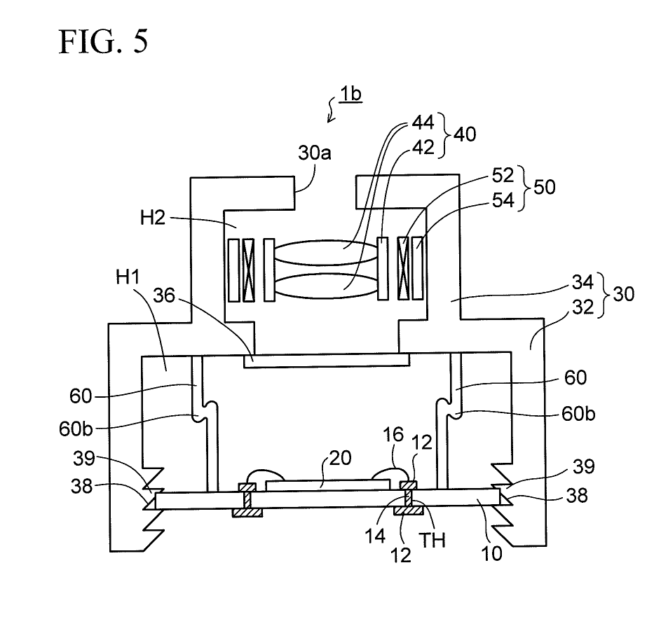

In FIG. 5, a camera module 1b according to a variation of the first embodiment is shown. In the camera module 1a in FIG. 3 described above, the top end part of the holding member 60 is shaped into the bending portion 60a so as to give the elasticity in the upper and lower direction. Also, like the camera module 1b of the variation in FIG. 5, a curving portion 60b may be provided to the half way position in the height direction of the holding member 60.

Also by this way, the holding member 60 has the elasticity in the upper and lower direction. Therefore, the height position of the wiring substrate 5 can be adjusted by fitting the wiring substrate 5 into the concave portion 38 at an optimum height in a state that the wiring substrate 5 is held from the upper side by the holding member 60. In FIG. 5, the elements except the holding member 60 are identical with those in FIG. 3, and therefore their explanation will be omitted herein.

In this case, as the method of giving the holding member 60 the elasticity in the upper and lower direction, an elasticity body such as a spring, or the like may be attached to the top end part of the holding members 60, in place of the formation of the bending portions 60a or the curving portions 60b. Otherwise, the holding member 60 itself may be formed of the elasticity body such as a spring, or the like, and may be fixed to the first frame portion 32.

In the present embodiment, as the preferred example, such a mode is explained that the holding member 60 having the elasticity in the upper and lower direction is provided. In the case that there is no need to hold the wiring substrate 5 from the upper side, the holding member 60 may be omitted.

Alternatively, the holding member 60 having no elasticity in the upper and lower direction may be provided to the lens holding frame 30. In this case, the top, end part of the holding member 60 is arranged in the position of the uppermost concave portion 38, and the holding member 60 functions as a stopper member when the wiring substrate 5 is fitted into the concave portion 38 of the lens holding frame 30.

### Second Embodiment

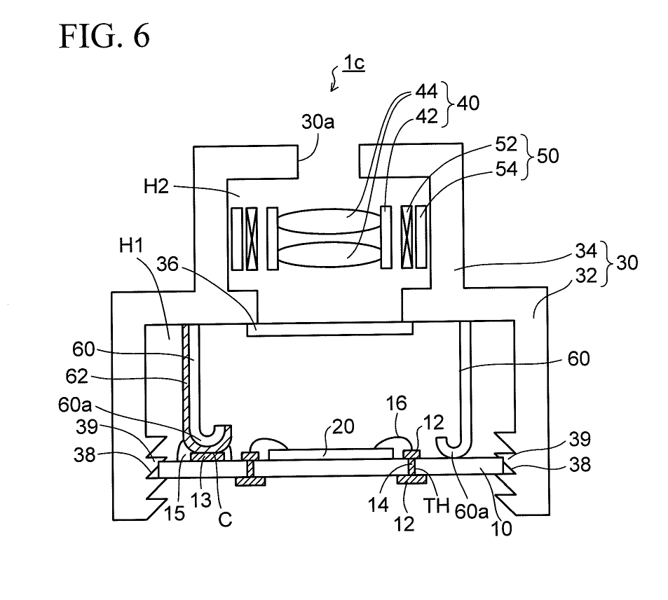

FIG. 6 is a sectional view showing a camera module according to a second embodiment of the present invention. A feature of the second embodiment resides in that a conductor layer is formed from the side surface of the holding member to the lower surface of the top end thereof, and thus the holding member is also used as the connection terminal connected electrically to the wiring substrate.

In FIG. 6, the elements except the elements associated with the holding member 60 are identical with those of the first embodiment in FIG. 3, and therefore their explanation will be omitted herein by affixing the same reference numerals to them.

As shown in FIG. 6, in a camera module 1c of the second embodiment, a conductor layer 62 is formed to extend from the side surface of the upper part of the holding member 60 to the lower surface of the bending portion 60a (the lower surface of the top end). The conductor layer 62 is connected electrically to the coil 52 of the voice coil motor 50. For example, the conductor layer 62 is formed by coating a conductive paste on the area from the side surface of the upper part of the holding member to the lower surface of the bending portion 60a thereof by the dispenser, or the like.

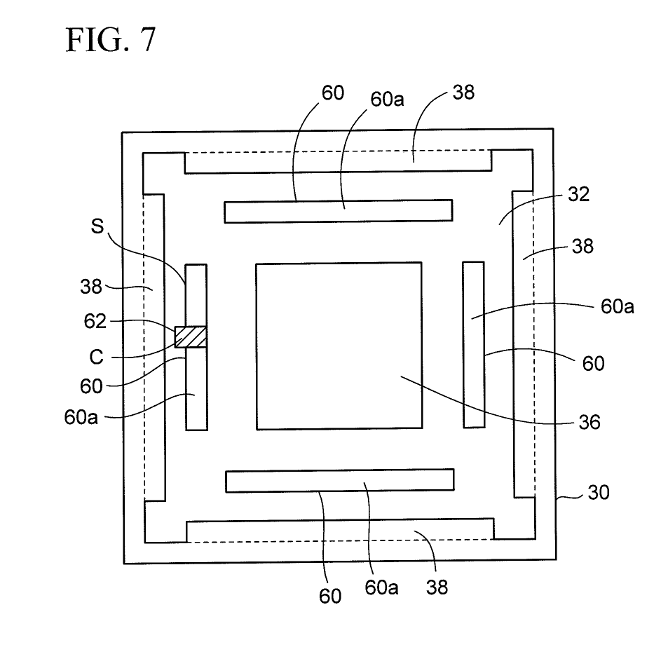

In FIG. 7, a state of the lens holding frame 30 in FIG. 6 before the camera module is assembled, when viewed from the lower side, is shown. As referred with adding FIG. 7, the concave portions 38 are provided to the lower side of the inner wall in four sides of the first frame portion 32 of the lens holding frame 30 respectively. Also, like the first embodiment, four holding members 60 having plate-like shape are provided to stand to the peripheral side of the ceiling portion of the first frame portion 32.

The belt-like conductor layer 62 is formed to extend from a part of a side surface S of the holding member 60 on someone's left hand side to the lower surface of the bending portion 60a, and the conductor layer 62 on the lower surface of the bending portion 60a (the lower surface of the top end of the holding member 60) constitutes a connection portion C. In FIG. 7, the lower surface of the bending portion 60a of the holding member 60 in FIG. 6 is depicted planarly.

Then, as shown in FIG. 6, like the first embodiment, the wiring substrate 5 is fitted into the concave portion 38 formed to the lower part of the inner wall of the lens holding frame 30. At this time, the connection portion C on the lower surface of the bending portion 60a of the holding member 60 is connected electrically to the connection pad 13 of the wiring substrate 5 by the connection conductor 15 such as the silver paste, or the like.

Accordingly, like the first embodiment, when a focus is adjusted, a required current is applied to the coil 52 of the voice coil motor 50 from the driver IC (not shown) mounted on the wiring substrate 5, and thus the voice coil motor 50 is driven.

The camera module 1c of the second embodiment can achieve the similar advantages to those of the first embodiment. In addition, in the second embodiment, the conductor layer 62 is formed from the side surface of the holding member 60 to the lower surface of the top end thereof, thereby the holding member 60 is also used as the connection terminal which is connected electrically to the connection pad 13 of the wiring substrate 5.

Therefore, unlike the first embodiment, there is no need to provide the connection terminal separately from the holding member 60, and as a result the structure of the second embodiment can be made more simply than the first embodiment.

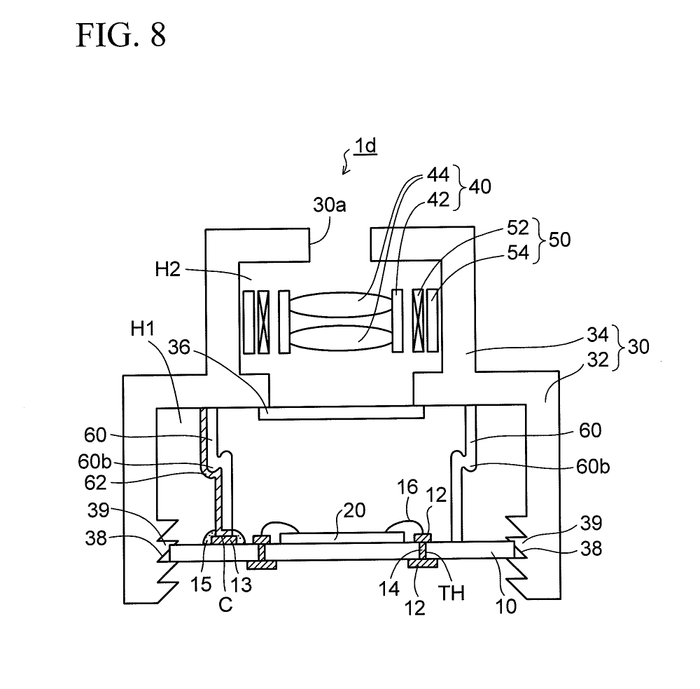

In FIG. 8, a camera module 1d according to a variation of the second embodiment is shown. As shown in FIG. 8, in the camera module 1d of the variation of the second embodiment, the belt-like conductor layer 62 is formed to extend from the side surface of the upper part of the holding member 60 in the camera module 1b of the variation of the first embodiment to the lower surface of the top end via the curving portion 60b. The conductor layer 62 on the lower surface of the top end of the holding member 60 constitutes the connection portion C.

Then, when the wiring substrate 5 is fitted into the concave portion 38 of the lens holding frame 30, similarly the connection portion C on the lower surface of the top end of the holding member 60 is connected electrically to the connection pad 13 of the wiring substrate 5 by the connection conductor 15 such as the silver paste, or the like. The camera module 1d of the variation can achieve the similar advantages to those of the camera module 1c in FIG. 6 described above.

(Mobile Terminal Unit Including the Camera Module of the Embodiment)

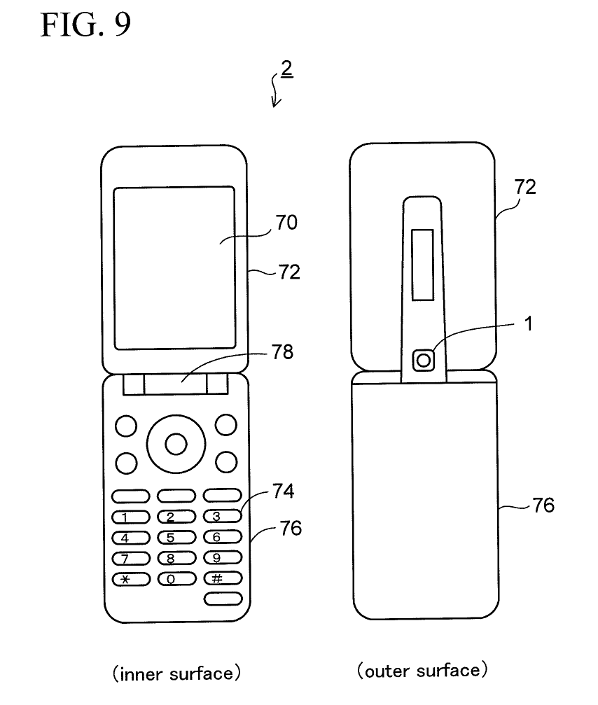

In FIG. 9, a cellular phone 2 (mobile terminal unit) in which the camera module 1a-1d in the first and second embodiments is built is shown. As shown in the vie of the inner surface of FIG. 9, in the cellular phone 2 of the present embodiment, an upper case 72 equipped with a display screen 70 is coupled to a lower case 76 equipped with operation buttons 74, etc. by a coupling portion 78 in a state that folding is possible.

Also, as shown in the view of outer surface of FIG. 9, the camera module 1a-1d in the above embodiments is arranged under the display screen 70 of the upper case 72. The camera module 1a-1d is installed into the upper case 7 such that the lens portion 40 is directed toward the surface side of the upper case 72 (the opposite surface to the display screen 70 side).

Then, the connection portion of the wiring layer 12 on the lower surface side of the wiring substrate 5 in the camera module 1a-1d is connected to the mounting substrate of the cellular phone 2.

In the cellular phone 2 of the present embodiment, since the camera module 1a-1d described above is built in, the miniaturization and the reduction of cost can be achieved.

What is claimed is:

1. A camera module, comprising:
a wiring substrate on which an imaging device is mounted to an upper surface side thereof; and
a lens holding frame arranged on the wiring substrate and in which a lens portion is housed;
wherein a plurality of concave portions are provided side by side to a lower side of an inner wall of the lens holding frame in a height direction, and
an end part of the wiring substrate is fitted into the concave portion of the lens holding frame and is fixed thereto.

2. A camera module according to claim 1, wherein the concave portions is formed like a V-shape between triangular-like convex portions.

3. A camera module according to claim 1, further comprising:
a holding member provided to stand toward a lower side to an inside part of the lens holding frame, and having elasticity in an upper and lower direction;
wherein a top end part of the holding member touches an upper surface of the wiring substrate, thereby the wiring substrate is held.

4. A camera module according to claim 3, wherein, in the holding member, the top end part is formed of a bending portion, or a halfway position in a height direction is formed of a curving portion.

5. A camera module according to claim 3, further comprising:
an actuator arranged in the lens holding frame, to drive the lens portion;
wherein a conductor layer connected to the actuator is provided to the holding member, the holding member also acts as a connection terminal of the lens holding frame, and the conductor layer is connected electrically to a connection pad of the wiring substrate.

6. A camera module according to claim 1, wherein, when the end part of the wiring substrate is fitted into the concave portion of the lens holding frame, the wiring substrate is fitted into the concave portion located in a position where a distance between the lens portion and the imaging device is set to a optimum state, out of a plurality of concave portions positioned side by side in a height direction, thereby a focus adjustment is done.

7. A mobile terminal unit, comprising:
the camera module set forth in any one of claims 1 to 6.
